(19) United States
(12) Patent Application Publication
(10) Pub. No.: US 2009/0107626 A1
(43) Pub. Date: Apr. 30, 2009

(54) ADHESION IMPROVEMENT OF DIELECTRIC BARRIER TO COPPER BY THE ADDITION OF THIN INTERFACE LAYER

(75) Inventors: Yong-Won Lee, San Jose, CA (US); Sang M. Lee, Cupertino, CA (US); Meiyee(Maggie Le) Shek, Palo Alto, CA (US); Weifeng Ye, Sunnyvale, CA (US); Li-Qun Xia, Santa Clara, CA (US); Derek R. Witty, Fremont, CA (US); Thomas Nowak, Cupertino, CA (US); Juan Carlos Rocha-Alvarez, San Carlos, CA (US); Jigang Li, Palo Alto, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: Applied Materials, Inc.

(21) Appl. No.: 12/258,300

(22) Filed: Oct. 24, 2008

Related U.S. Application Data
(60) Provisional application No. 60/982,571, filed on Oct. 25, 2007.

(51) Int. Cl. B32B 37/00

(52) U.S. Cl. 156/275.7

(57) ABSTRACT

Embodiments described herein provide a method of processing a substrate. The method includes depositing an interface adhesion layer between a conductive material and a dielectric material such that the interface adhesion layer provides increased adhesion between the conductive material and the dielectric material. In one embodiment a method for processing a substrate is provided. The method comprises depositing an interface adhesion layer on a substrate comprising a conductive material, exposing the interface adhesion layer to a nitrogen containing plasma, and depositing a dielectric layer on the interface adhesion layer after exposing the interface adhesion layer to the nitrogen containing plasma.

### CROSS-REFERENCE TO RELATED APPLICATIONS

This application claims benefit of U.S. Provisional Patent Application Ser. No. 60/982,571, filed Oct. 25, 2007, which is herein incorporated by reference.

### BACKGROUND OF THE INVENTION

1. Field of the Invention

Embodiments described herein relate to the fabrication of integrated circuits. More particularly, embodiments described herein relate to a method and apparatus for processing a substrate that improve adhesion between a conductive material and a dielectric material.

2. Description of the Related Art

Integrated circuits have evolved into complex devices that can include millions of components (e.g., transistors, capacitors and resistors) on a single chip. The evolution of chip designs continually requires faster circuitry and greater circuit densities. The demand for greater circuit densities necessitates a reduction in the dimensions of the integrated circuit components.

As the dimensions of the integrated circuit components are reduced (e.g., sub-micron dimensions), the materials used to fabricate such components contribute to the electrical performance of such components. For example, low resistivity metal interconnects (e.g., aluminum and copper) provide conductive paths between the components on integrated circuits.

One method for forming vertical and horizontal interconnects is by a damascene or dual damascene method. In the damascene method, one or more dielectric materials, such as the low k dielectric materials, are deposited and pattern etched to form the vertical interconnects, i.e. vias, and horizontal interconnects, i.e., lines. Conductive materials, such as copper containing materials, and other materials, such as barrier layer materials used to prevent diffusion of copper containing materials into the surrounding low k dielectric, are then inlaid into the etched pattern. Any excess copper containing materials and excess barrier layer material external to the etched pattern, such as on the field of the substrate, are then removed and a planarized surface is formed. A dielectric layer, such as an insulative layer or barrier layer is formed over the copper feature for subsequent processing, such as forming a second layer of damascene structures.

However, it has been observed that certain dielectric layers having superior electrical properties exhibit poor adhesion with copper features. This poor adhesion between the dielectric layers and the copper features leads to increased capacitive coupling between adjacent metal interconnects causing cross-talk and/or resistance-capacitance (RC) delay, which degrades the overall performance of the integrated circuit.

Therefore, there remains a need for a process for improving interlayer adhesion between the low k dielectric layers overlying copper features.

### SUMMARY OF THE INVENTION

Embodiments described herein provide a method of processing a substrate. The method includes depositing an interface adhesion layer between a conductive material and a dielectric material such that the interface adhesion layer provides increased adhesion between the conductive material and the dielectric material. In one embodiment a method for processing a substrate is provided. The method comprises depositing an interface adhesion layer on a substrate comprising a conductive material, exposing the interface adhesion layer to a nitrogen containing plasma, and depositing a dielectric layer on the interface adhesion layer after exposing the interface adhesion layer to the nitrogen containing plasma.

In another embodiment a method for processing a substrate is provided. The method comprises providing a substrate comprising a conductive material, flowing a first silicon based compound over the surface of the conductive material to form a silicide layer, treating the silicide layer with a nitrogen containing plasma to form a nitrosilicide layer, depositing an interface adhesion layer on the substrate by flowing a second silicon based compound over the substrate while maintaining the nitrogen containing plasma, and depositing a dielectric layer on the substrate.

In yet another embodiment a method for processing a substrate is provided. The method comprises providing a substrate comprising a conductive material, flowing a first silicon based compound over the surface of the conductive material to form a silicide layer, applying an RF power to form a nitrogen containing plasma, treating the substrate with the nitrogen containing plasma to form a nitrosilicide layer, depositing an interface adhesion layer on the substrate by flowing a second silicon based compound over the substrate while maintaining the RF power, and depositing a dielectric layer on the substrate.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1D are cross-sectional views showing one embodiment of a dual damascene deposition sequence according to one embodiment described herein;

FIG. 2 is a process flow diagram illustrating a method according to one embodiment described herein for forming a thin interface adhesion layer;

FIGS. 3A-3C are cross-sectional views showing a thin interface adhesion layer formed according to one embodiment described herein;

FIG. 4 is a process flow diagram illustrating another method according to one embodiment described herein for forming a thin interface adhesion layer;

FIGS. 5A-5E are cross-sectional views showing one embodiment of a dual damascene deposition sequence incorporating an interface adhesion layer according to one embodiment described herein;

FIG. 6 is a cross sectional view showing one embodiment of a stack formed according to one embodiment described herein;

FIG. 7 is a cross sectional schematic diagram of an exemplary processing chamber that may be used for practicing embodiments described herein;

FIG. 8 is a graph demonstrating the FTIR spectra of SiN films deposited according to embodiments described herein;

FIG. 9 demonstrates interfacial adhesion energy improvement (Gc) by a SiN film prior to silicon carbide deposition;

FIG. 10 is a process flow diagram illustrating a method according to one embodiment described herein for forming a thin interface adhesion layer;

FIG. 11 is a graph demonstrating the improvement in adhesion properties of a silicon rich silicon nitride film;

FIG. 12A is a graph demonstrating the FTIR spectra of candidate SiN films both pre and post nitridation;

FIG. 12B is a graph demonstrating the improvement in dielectric properties of a silicon nitride film after a post deposition nitridation treatment;

FIG. 13A is a graph demonstrating the improvement in breakdown voltage (Vbd) for a dielectric film after post deposition nitridation treatment; and

FIG. 13B is a graph demonstrating the improvement in leakage current at 2 MV (A/cm²) for a dielectric film after post deposition nitridation treatment.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

Embodiments described herein provide a method of processing a substrate including depositing a thin interface adhesion layer between a conductive material and a dielectric material such that the thin interface adhesion layer provides increased adhesion between the conductive material and the dielectric material. In certain embodiments, the thin interface adhesion layer is a silicon nitride layer. In certain embodiments, a silicide of the conductive material is formed followed by deposition of the thin interface adhesion layer on the silicide layer. In certain embodiments, a plasma nitridation process is performed on the silicide layer to form a nitrosilicide layer prior to deposition of the thin interface adhesion layer. In certain embodiments, the silicide layer and the interface adhesion layer are formed using RF back-to-back with a minimum transition in process conditions. For example, at least one of the plasma process conditions, such as RF power, used during nitridation of the silicide layer is maintained during deposition of the thin interface adhesion layer. In certain embodiments, the silicide material is copper silicide, and the thin interface adhesion layer comprises silicon nitride (SiN). In certain embodiments, the nitrosilicide layer comprises CuSiN. In certain embodiments, the conductive material comprises copper and the dielectric material comprises silicon carbide.

While the following description details the use of a thin interface adhesion layer to improve interlayer adhesion between a conductive material and a dielectric material for a dual damascene structure, the embodiments described herein should not be construed or limited to the illustrated examples, as the embodiments contemplate that other structures, formation processes, and straight deposition processes may be performed using the adhesion aspects described herein.

The following deposition processes are described with use of the 300 mm PRODUCER® dual deposition station processing chamber, and should be interpreted accordingly. For example, flow rates are total flow rates and should be divided by two to describe the process flow rates at each deposition station in the chamber. Additionally, it should be noted that the respective parameters may be modified to perform the plasma processes in various chambers and for different substrate sizes, such as for 200 mm substrates. Further, while the following process is described for copper and silicon carbide, the embodiments described herein contemplate this process may be used with other conductive materials and dielectric materials used in semiconductor manufacturing.

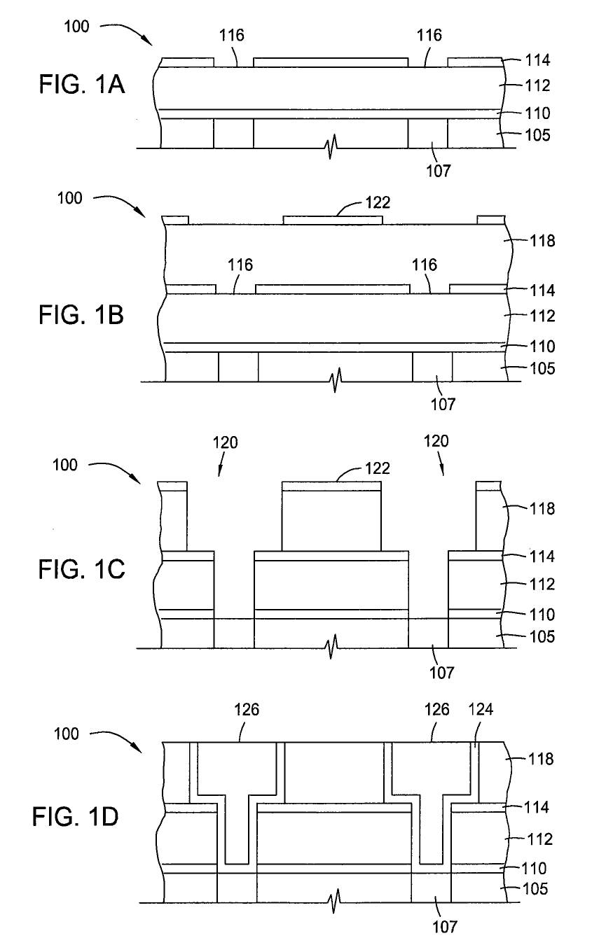

As shown in FIG. 1A, a damascene structure that is formed using a substrate 100 having metal features 107 formed in a substrate surface material 105 therein is provided to a processing chamber. A first barrier layer 110, such as a silicon carbide barrier layer, is generally deposited on the substrate surface to eliminate inter-level diffusion between the substrate and subsequently deposited material. Barrier layer materials may have dielectric constants of up to about 9 and preferably between about 2.5 and less than about 4. Silicon carbide barrier layers may have dielectric constants of about 5 or less, preferably less than about 4.

The silicon carbide material of the first barrier layer 110 may be doped with nitrogen and/or oxygen. While not shown, a capping layer of nitrogen free silicon carbide or silicon oxide may be deposited on the first barrier layer 110. The nitrogen free silicon carbide or silicon oxide capping layer may be deposited in-situ by adjusting the composition of the processing gas. For example, a capping layer of nitrogen free silicon carbide may be deposited in-situ on the first silicon carbide barrier layer 110 by minimizing or eliminating the nitrogen source gas. Alternatively, and not shown, an initiation layer may be deposited on the first silicon carbide barrier layer 112. Initiation layers are more fully described in U.S. Pat. No. 7,030,041, entitled ADHESION IMPROVEMENT FOR LOW K DIELECTRICS, which is incorporated herein by reference to the extent not inconsistent with the claimed aspects and disclosure herein.

The first dielectric layer 112 is deposited on the silicon carbide barrier layer 110 to a thickness of about 1,000 to about 15,000 Å, depending on the size of the structure to be fabricated, by oxidizing an organosilicon compound, which may include trimethylsilane and/or octamethylcyclotetrasiloxane. The first dielectric layer 112 may then be post-treated with a plasma or e-beam process. Optionally, a silicon oxide cap layer (not shown) may be deposited in-situ on the first dielectric layer 112 by increasing the oxygen concentration in the silicon oxycarbide deposition process described herein to remove carbon from the deposited material. The first dielectric layer may also comprise other low k dielectric material such as a low polymer material including paralyne or a low k spin-on glass such as un-doped silicon glass (USG) or fluorine-doped silicon glass (FSG). The first dielectric layer may then be treated by a plasma process as described herein.

An optional low-k etch stop (or second barrier layer) 114, for example, a silicon carbide layer, which may be doped with nitrogen or oxygen, is then deposited on the first dielectric layer 112. The low-k etch stop 114 may be deposited on the first dielectric layer 112 to a thickness of about 50 Å to about 1,000 Å. The low-k etch stop 114 may be plasma treated as described herein for the silicon carbide materials or silicon oxycarbide materials. The low-k etch stop 114 is then pattern etched to define the openings of the contacts/vias 116 and to expose the first dielectric layer 112 in the areas where the contacts/vias 116 are to be formed. In one embodiment, the low k etch stop 114 is pattern etched using conventional photolithography and etch processes using fluorine, carbon, and oxygen ions. While not shown, a nitrogen-free silicon carbide or silicon oxide cap layer between about 100 Å to about 500 Å may optionally be deposited on the low k etch stop 114 prior to depositing further materials.

Referring to FIG. 1B, a second dielectric layer 118 of an oxidized organosilane or organosiloxane is then deposited over the optional patterned etch stop 114 and the first dielectric layer 112 after the resist material has been removed. The second dielectric layer 118 may comprise silicon oxycarbide from an oxidized organosilane or organosiloxane by the process described herein, such as trimethylsilane, is deposited to a thickness of about 5,000 to about 15,000 Å. The second dielectric layer 118 may then be plasma or e-beam treated and/or have a silicon oxide cap material disposed thereon by the process described herein.

A resist material 122 is then deposited on the second dielectric layer 118 (or cap layer) and patterned using conventional photolithography processes to define the interconnect lines 120 as shown in FIG. 1B. Optionally an ARC layer and an etch mask layer, such as a hardmask layer (not shown) may be positioned between the resist material 122 and the second dielectric layer 118 to facilitate transferring patterns and features to the substrate 100. The resist material 122 comprises a material conventionally known in the art, preferably a high activation energy resist material, such as UV-5, commercially available from Shipley Company Inc., of Marlborough, Mass. The interconnects and contacts/vias are then etched using reactive ion etching or other anisotropic etching techniques to define the metallization structure (i.e., the interconnect and contact/via) as shown in FIG. 1C. Any resist material or other material used to pattern the etch stop 114 or the second dielectric layer 118 is removed using an oxygen strip or other suitable process.

The metallization structure is then formed with a conductive material such as aluminum, copper, tungsten or combinations thereof. Presently, the trend is to use copper to form the smaller features due to the low resistivity of copper (1.7 mΩ-cm compared to 3.1 mΩ-cm for aluminum). In one embodiment, a suitable metal barrier layer 124, such as tantalum nitride, is first deposited conformally in the metallization pattern to prevent copper migration into the surrounding silicon and/or dielectric material. Thereafter, copper is deposited using techniques such as chemical vapor deposition, physical vapor deposition, electroplating, or combinations thereof to form the conductive structure. Once the structure has been filled with copper or other conductive metal, the surface is planarized using chemical mechanical polishing and exposing the surface of the conductive metal feature 126, as shown in FIG. 1D.

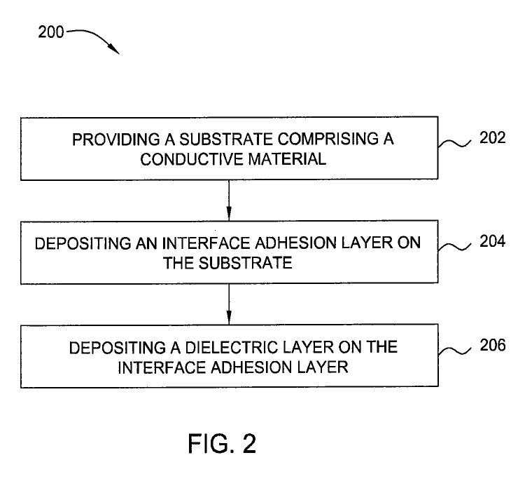

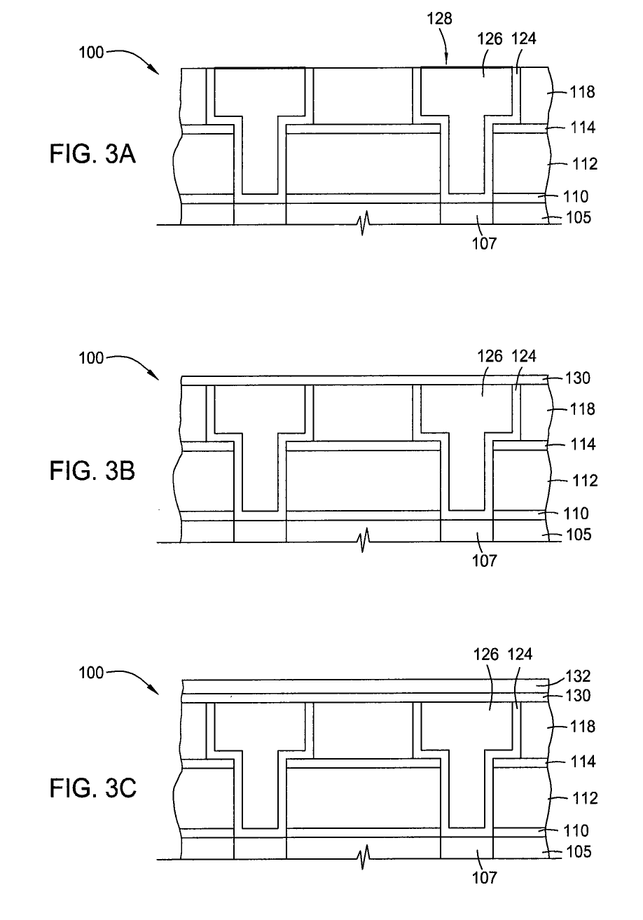

FIG. 2 is a process flow diagram illustrating a method 200 according to one embodiment described herein for forming a thin interface adhesion layer. The method 200 starts at step 202 by providing a substrate 100 comprising a conductive material 126 having an exposed surface 128 disposed on the substrate as shown in FIG. 3A. The conductive materials 126 may be fabricated from Sn, Ni, Cu, Au, Al, combinations thereof, and the like. Conductive materials 126 may also include a corrosion resistant metal such as Sn, Ni, or Au coated over an active metal such as Cu, Zn, Al, and the like. In certain embodiments, the substrate further comprises a silicon containing layer, a first dielectric layer 112 and a second dielectric layer 118 circumscribing the conductive material 126. In one embodiment, the first dielectric layer 112 and the second dielectric layer 118 formed on the substrate 100 may be a low-k dielectric layer having a dielectric constant lower than 4.0, such as silicon oxycarbide layer, such as BLACK DIAMOND®, commercially available from Applied Materials Inc., Santa Clara, Calif., may be utilized to form the first and the second dielectric barrier layer 112, 118. In certain embodiments, the conductive material 126 and the first dielectric layer 112 and the second dielectric layer 118 formed on the substrate 100 comprise a damascene structure.

In step 204, an interface adhesion layer 130, as shown in FIG. 3B, is deposited on the substrate 100. In certain embodiments, the interface adhesion layer 130 is a silicon nitride layer with a thickness between about 1 Å and about 100 Å, between about 2 Å and about 50 Å, for example, between about 3 Å and about 10 Å. In certain embodiments, where the interface adhesion layer 130 is silicon nitride, the silicon nitride layer has a low hydrogen content. Optionally, a metal oxide removal process may be performed prior to deposition of the interface adhesion layer 130.

The silicon nitride layer may be formed by flowing a silicon based compound over the substrate 100. The silicon based compound may comprise a carbon-free silicon compound including silane (SiH₄), disilane (Si₂H₆), trisilane (Si₃H₈), trisilylamine ((SiH₃)₃N or TSA), derivatives thereof, and combinations thereof. The silicon based compound may also comprise a carbon-containing silicon compound including organosilicon compounds described herein, for example, methylsilane (CH₃SiH₃), trimethylsilane (TMS), derivatives thereof, and combinations thereof.

In certain embodiments, wherein the thin interface adhesion layer 130 is a silicon nitride layer, the silicon nitride layer may be deposited by flowing the silicon based compound to a processing chamber at a flow rate between about 50 sccm and about 1000 sccm, for example, between about 250 sccm and about 500 sccm, providing a nitrogen-containing compound, such as the reducing compounds described herein, to a processing chamber at a flow rate between about 500 sccm and about 2,500 sccm, for example, between about 1,250 sccm and about 1,750 sccm optionally providing an inert gas, such as helium or nitrogen, to a processing chamber at a flow rate between about 100 sccm and about 20,000 sccm, for example, between about 15,000 sccm and about 19,000 sccm, maintaining a chamber pressure between about 1 Torr and about 12 Torr, for example, between about 2.5 Torr and about 9 Torr, maintaining a heater temperature between about 100° C. and about 500° C., for example, between about 250° C. and about 450° C., positioning a gas distributor, or “showerhead”, between about 200 mils and about 1000 mils, for example between 300 mils and 500 mils from the substrate surface, and generating a plasma. In one embodiment, the plasma treatment may be performed between about 1 second and about 30 seconds, for example, between about 1 second and about 15 seconds.

The plasma may be generated by applying a power density ranging between about 0.03 W/cm² and about 3.2 W/cm², which is a RF power level of between about 10 W and about 1,000 W for a 300 mm substrate, for example, between about 100 W and about 400 W at a high frequency such as between 13 MHz and 14 MHz, for example, 13.56 MHz. The plasma may be generated by applying a power density ranging between about 0.01 W/cm² and about 1.4 W/cm², which is a RF power level of between about 10 W and about 1,000 W for a 300 mm substrate, for example, between about 100 W and about 400 W at a high frequency such as between 13 MHz and 14 MHz, for example, 13.56 MHz. Alternatively, the plasma may be generated by a dual-frequency RF power source as described herein. Alternatively, all plasma generation may be performed remotely, with the generated radicals introduced into the processing chamber for plasma treatment of a deposited material or deposition of a material layer.

In step 206, a barrier dielectric layer 132 is deposited on the interface adhesion layer 130. In certain embodiments, the barrier dielectric layer 132 comprises a silicon carbide material. The barrier dielectric layer 132 may be deposited by, for example, by continuously introducing an organosilicon compound described herein or by adjusting the silicon carbide precursor gas flow rates and any dopants, carrier gases, or other compounds as described herein to deposit a silicon carbide layer having desired properties. The continuous flow of organosilicon precursor during or immediately following the reducing compound treatment process allows for the removal of oxides, the formation of a nitrated layer and deposition of the silicon carbide layer to be performed in-situ. Processes for depositing silicon carbide are described in U.S. Pat. No. 6,537,733, entitled METHOD OF DEPOSITING LOW DIELECTRIC CONSTANT SILICON CARBIDE LAYERS, U.S. Pat. No. 6,759,327, entitled DEPOSITING LOW K BARRIER FILMS (k<4) USING PRECURSORS WITH BULKY ORGANIC FUNCTIONAL GROUPS, and U.S. Pat. No. 6,890,850, entitled METHOD OF DEPOSITING LOWER K HARDMASK AND ETCH STOP FILMS, which are all incorporated herein by reference to the extent not inconsistent with the claimed aspects and disclosure herein.

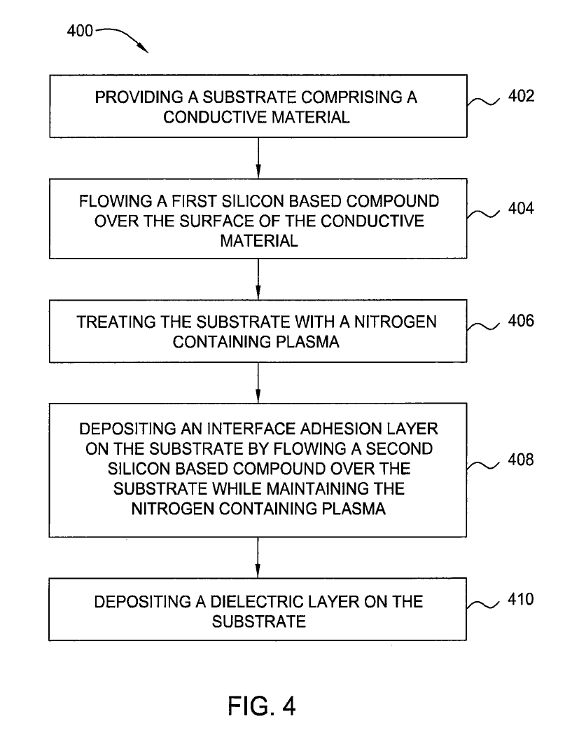

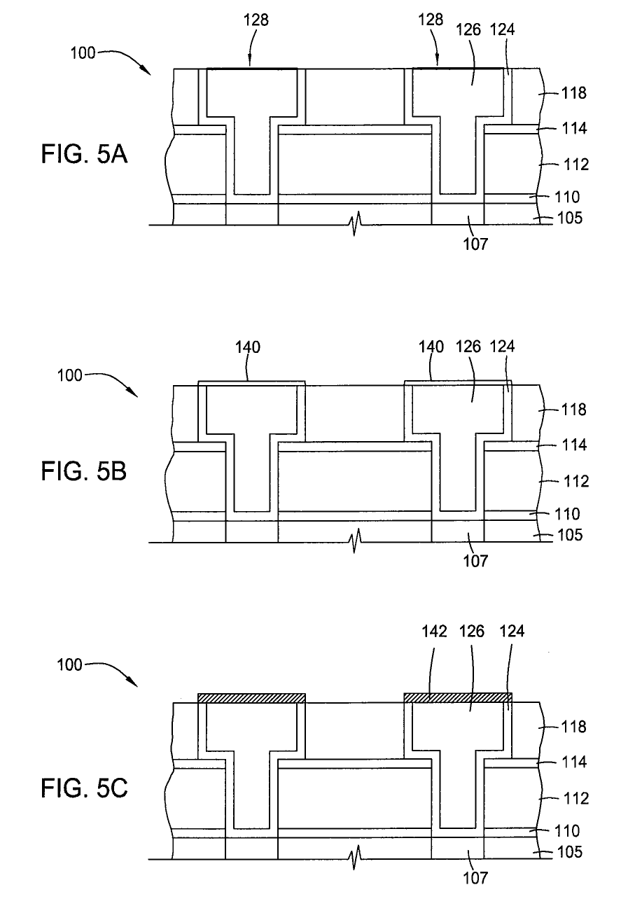

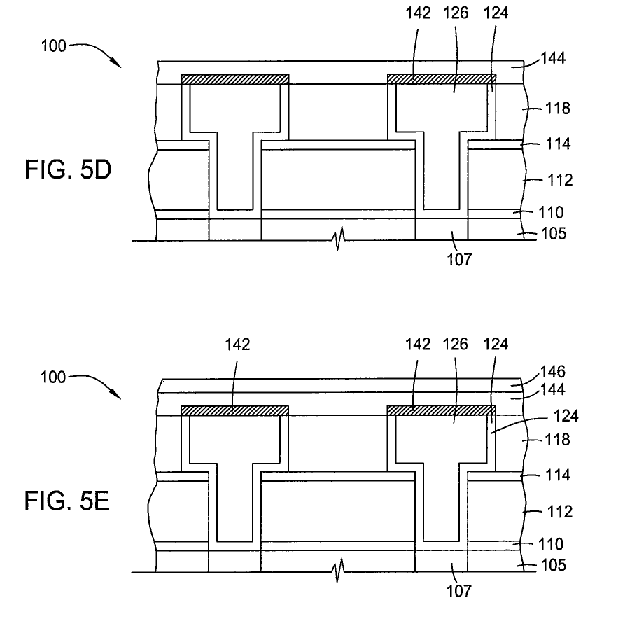

With reference to FIG. 4 and FIGS. 5A-5E, in another embodiment of the methods described herein, interlayer adhesion may be improved by forming an interface adhesion layer, such as a silicon nitride layer. The silicon nitride layer may be formed by introducing a silicon containing gas, such as trisilylamine, into a process chamber while maintaining the process conditions, such as the RF power, that were used during nitridation of a silicide layer.

FIG. 4 is a process flow diagram illustrating another method 400 according to one embodiment described herein for forming a thin interface adhesion layer 144 on a substrate 100. The method 400 starts at step 402 by providing a substrate 100 comprising a conductive material 126 having an exposed surface 128 disposed on the substrate 100, as shown in FIG. 5A. The conductive materials 126 may be fabricated from Sn, Ni, Cu, Au, Al, combinations thereof, and the like. Conductive materials 126 may also include a corrosion resistant metal such as Sn, Ni, or Au coated over an active metal such as Cu, Zn, Al, and the like. In certain embodiments, the substrate further comprises a silicon containing layer, a first dielectric layer 112 and a second dielectric layer 118 circumscribing the conductive material 126. In one embodiment, the first dielectric layer 112 and the second dielectric layer 118 formed on the substrate 100 may be a low-k dielectric layer having a dielectric constant lower than 4.0, such as silicon oxycarbide layer, such as BLACK DIAMOND®, commercially available from Applied Materials Inc., Santa Clara, Calif., may be utilized to form the first and the second dielectric barrier layer 112, 118. In certain embodiments, the conductive material 126 and the first dielectric layer 112 and the second dielectric layer 118 formed on the substrate 100 comprise a damascene structure.

In one embodiment, a pre-treatment process having nitrogen plasma is performed to treat the upper surface of the second dielectric layer 118 and the exposed surface 128 of the conductive material 126. The pre-treatment process may assist removing metal oxide, native oxide, particles, or contaminants from the substrate surface. In one embodiment, the gases utilized to treat the substrate 100 include N₂, N₂O, NH₃, NO₂, and the like. In a certain embodiment depicted herein, the nitrogen containing gas used to pre-treat the second dielectric layer 118 and the exposed surface 128 of the conductive material 126 is ammonia (NH₃) or nitrogen gas (N₂).

In one embodiment, the pre-treatment process is performed by generating a plasma in a gas mixture supplied to the processing chamber. The plasma may be generated by applying a power density ranging between about 0.03 W/cm² and about 3.2 W/cm², which is a RF power level of between about 10 W and about 1,000 W for a 300 mm substrate, for example, between about 100 W and about 400 W at a high frequency such as between 13 MHz and 14 MHz, for example, 13.56 MHz. The plasma may be generated by applying a power density ranging between about 0.01 W/cm² and about 1.4 W/cm², which is a RF power level of between about 10 W and about 1,000 W for a 300 mm substrate, for example, between about 100 W and about 400 W at a high frequency such as between 13 MHz and 14 MHz, for example, 13.56 MHz. Alternatively, the plasma may be generated by a dual-frequency RF power source as described herein. Alternatively, all plasma generation may be performed remotely, with the generated radicals introduced into the processing chamber for plasma treatment of a deposited material or deposition of a material layer.

In step 404, a first silicon based compound is flowed over the exposed surface 128 of the conductive material 126. The silicon based compound reacts with the conductive material 126 to form a metal silicide layer 140 over the conductive material 126 as shown in FIG. 5B. The silicon atoms from the silicon based compound are adhered and absorbed on the surface of the conductive material 126 on the substrate 100, thereby forming metal silicide layer 140 on the substrate 100. In embodiments wherein the conductive material 126 on the substrate 100 is a copper layer, the silicon atoms are adhered and absorbed on the copper surface, thereby forming a copper silicide layer on the surface of the conductive layer 126.

In one embodiment, the silicon based compound supplied to the surface of the conductive material 126 may be performed using a thermal process, e.g., without the presence of a plasma. In this particular embodiment, the silicide may be formed mainly on the exposed surface 128 of the conductive material 126. The thermal energy causes the silicon atoms from the silicon based compound to mainly be absorbed on the copper atoms of the conductive material 126, forming the silicide layer 140 on the exposed surface 128 of the conductive material 126. Alternatively, in the embodiment wherein the silicon based compound supplied to the processing chamber is performed by a plasma process, the silicide layer 140 may be formed all over the surface of the substrate 100, such as on both the surface of the conductive material 126 and dielectric material 118. In the embodiment wherein the conductive material 126 is a copper layer, the silicide layer 142 formed on the substrate 100 is a copper silicide (CuSi) layer.

The silicon based compound may comprise a carbon-free silicon compound including silane (SiH₄), disilane (Si₂H₆), trisilane (Si₃H₈), trisilylamine ((SiH₃)₃N or TSA), derivatives thereof, and combinations thereof. The silicon based compound may also comprise a carbon-containing silicon compound including organosilicon compounds described herein, for example, methylsilane (CH₃SiH₃), trimethylsilane (TMS), derivatives thereof, and combinations thereof. The silicon based compound may react with the exposed conductive material by thermally and/or alternatively, plasma enhanced process. Dopants, such as oxygen containing and nitrogen containing dopants, for example, NH₃, may be used with the silicon based compounds as described herein. Additionally, an inert gas, such as a noble gas including helium and argon, may be used during the silicide process, and may be used as a carrier gas for the thermal process or as an additional plasma species for the plasma enhanced silicide formation process. The silicon based compound may further include a dopant, such as the reducing compound described herein, to form a nitrosilicide. In such an embodiment, the reducing compound may be delivered as described herein.

In one embodiment, a silicide process with the silicon based compounds described herein includes providing silicon based compounds to a processing chamber at a flow rate between about 10 sccm and about 1,000 sccm, for example, between about 50 sccm and about 200 sccm. Optionally, an inert gas, such as helium, argon, or nitrogen, may also by supplied to a processing chamber at a flow rate between about 100 sccm and about 20,000 sccm, for example, between about 2,000 sccm and about 19,000 sccm. The process chamber pressure may be maintained between about 0.5 Torr and about 12 Torr, for example, between about 2 Torr and about 9 Torr. The heater temperature may be maintained between about 100° C. and about 500° C., for example, between about 250° C. and about 450° C. The gas distributor or “showerhead” may be positioned between about 200 mils and about 1000 mils, for example between 200 mils and 600 mils from the surface of the substrate 100.

In another embodiment, the silicon based compound is provided to the processing chamber at a flow rate between about 40 sccm and about 5,000 sccm, for example, between about 1,000 sccm and about 2,000 sccm. Optionally, an inert gas, such as helium, argon or nitrogen, may also be supplied to a processing chamber at a flow rate between about 100 sccm and about 20,000 sccm, for example, between about 15,000 sccm and about 19,000 sccm. The process chamber pressure may be maintained between about 1 Torr and about 8 Torr, for example, between about 3 Torr and about 5 Torr. The heater temperature may be maintained between about 100° C. and about 500° C., for example, between about 250° C. and about 450° C., such as less than 300° C. A spacing between a gas distributor, or showerhead of between about 200 mils and about 1,000 mils, for example between 300 mils and 500 mils from the substrate surface. The silicide layer formation process may be performed between about 1 second and about 20 seconds, for example, between about 1 second and about 10 seconds.

The silicide formation process may be further enhanced by generating a plasma. The plasma may be generated by applying a power density ranging between about 0.03 W/cm² and about 6.4 W/cm², which is a RF power level of between about 10 W and about 2,000 W for a 200 mm substrate, for example, between about 100 W and about 400 W at a high frequency such as between 13 MHz and 14 MHz, for example, 13.56 MHz. The plasma may be generated by applying a power density ranging between about 0.01 W/cm² and about 2.8 W/cm², which is a RF power level of between about 10 W and about 2,000 W for a 300 mm substrate, for example, between about 100 W and about 400 W at a high frequency such as between 13 MHz and 14 MHz, for example, 13.56 MHz. Alternatively, the plasma may be generated by a dual-frequency RF power source as described herein. Alternatively, all plasma generation may be performed remotely, with the generated radicals introduced into the processing chamber for plasma treatment of a deposited material or deposition of a material layer. The plasma may be generated between about 1 second and about 60 seconds, for example, between about 1 second and about 5 seconds for formation of the silicide layer.

One example of the silicide process includes providing trisilylamine to a processing chamber at a flow rate of about 350 sccm, providing nitrogen to a processing chamber at a flow rate of about 5,000 sccm, maintaining a chamber pressure at about 4 Torr, maintaining a heater temperature of about 350° C., positioning a gas distributor, or “showerhead”, at about 300 mils, for about 5 seconds.

Another example of the silicide process includes providing trisilylamine to a processing chamber at a flow rate of about 125 sccm, providing nitrogen to a processing chamber at a flow rate of about 18,000 sccm, maintaining a chamber pressure at about 4.2 Torr, maintaining a heater temperature of about 350° C., providing a spacing between a gas distributor, or showerhead of about 350 mils from the substrate, for about 4 seconds.

In step 406, the substrate 100 is treated with a nitrogen containing plasma forming a metal nitrosilicide layer 142 on the substrate 100, as shown in FIG. 5C. In one embodiment, treatment with the nitrogen containing plasma may be performed by supplying a nitrogen containing gas to the silicide layer 140 in the presence of plasma to treat the silicide layer 140, incorporating nitrogen atoms in the surface of the silicide layer 140, thereby converting the silicide layer 140 into the metal nitrosilicide layer 142. In one embodiment, the thickness of the metal nitrosilicide layer 142 is less than about 50 Å, such as between about 30 Å to about 40 Å. Suitable examples of the nitrogen containing gas include N₂, N₂O, NH₃, NO₂, combinations thereof, and the like. In a certain embodiment depicted herein, the nitrogen containing gas used to treat the silicide layer 140 is ammonia (NH₃). The plasma may further comprise an inert gas, such as helium, argon, or combinations thereof.

In one embodiment, the process time for performing the silicide formation process at step 406 and post plasma nitridation treatment process at step 406 is controlled at between about 1:5 to about 5:1, such as about 1:3 and about 3:1. In another embodiment, the process time for performing the silicide formation process at step 406 is controlled less than about 10 seconds, such as less than about 5 seconds, and the post plasma nitridation treatment process at step 406 is controlled at less than about 30 seconds, such as less than 15 seconds. In yet another embodiment, the process time for performing the silicide formation process step 404 is less than the process time for performing the post plasma nitridation treatment process at step 406.

The nitrogen source for the nitrogen containing plasma may be nitrogen (N₂), NH₃, N₂O, NO₂, or combinations thereof. The plasma may further comprise an inert gas, such as helium, argon, or combinations thereof. The pressure during the plasma exposure of the substrate may be between about 1 Torr and about 30 Torr, such as between about 1 Torr and about 10 Torr. Besides N₂, other nitrogen-containing gases may be used to form the nitrogen plasma, such as H₃N hydrazines (e.g., N₂H₄ or MeN₂H₃), amines (e.g., Me₃N, Me₂NH or MeNH₂), anilines (e.g., C₅H₅NH₂), and azides (e.g., MeN₃ or Me₃SiN₃). Other noble gases that may be used include helium, neon, and xenon. The nitridation process proceeds at a time period from about 10 seconds to about 360 seconds, for example, from about 0 seconds to about 60 seconds, for example, about 15 seconds.

The RF power selected to perform the nitridation treatment process may be controlled substantially similar to the RF power selected to perform the nitrogen plasma pre-treatment process of the substrate 100. In one embodiment, the plasma may be generated by applying a power density ranging between about 0.03 W/cm² and about 3.2 W/cm², which is a RF power level of between about 10 W and about 1,000 W for a 300 mm substrate, for example, between about 100 W and about 600 W at a high frequency such as between 13 MHz and 14 MHz, for example, 13.56 MHz. The plasma may be generated by applying a power density ranging between about 0.01 W/cm² and about 1.4 W/cm², which is a RF power level of between about 10 W and about 1,000 W for a 300 mm substrate, for example, between about 100 W and about 400 W at a high frequency such as between 13 MHz and 14 MHz, for example, 13.56 MHz. Alternatively, the plasma may be generated by a dual-frequency RF power source as described herein. Alternatively, all plasma generation may be performed remotely, with the generated radicals introduced into the processing chamber for plasma treatment of a deposited material or deposition of a material layer.

In one embodiment, the nitridation process is conducted with a RF power setting at about 300 watts to about 2,700 watts and a pressure at about 1 Torr to about 20 Torr. A nitrogen containing gas has a flow rate from about 0.1 slm to about 15 slm. In one embodiment, the nitrogen containing gas including a gas mixture having a nitrogen and an ammonia gas is supplied into the processing chamber. The nitrogen gas is supplied to the chamber between about 0.5 slm and about 1.5 slm, for example, about 1 slm and the ammonia gas is supplied to the chamber between about 5 slm and about 15 slm, such as about 10 slm.

The individual and total gas flows of the processing gases may vary based upon a number of processing factors, such as the size of the processing chamber, the temperature of the processing chamber, and the size of the substrate being processed. The process chamber pressure may be maintained between about 1 Torr and about 10 Torr, for example, between about 2 Torr and about 5 Torr, such as about 3.7 Torr. The heater temperature may be maintained between about 100° C. and about 500° C., for example, between about 250° C. and about 450° C., such as less than 350° C.

In one embodiment, the nitrosilicide layer 142 acts as an interface adhesion layer that promotes adhesion between the conductive material 126 and the subsequent to-be-deposited film. The nitrosilicide layer 142 serves as an adhesion enhancement layer that bridges the copper atoms from the conductive material 126 and the silicon and nitrogen atoms from the silicide formation process at step 404, thereby forming strong bonding at the interface. The strong bonding of the nitrosilicide layer 142 to the conductive material 126 enhances the adhesion between the conductive material 126 and the subsequently to-be deposited layers, thereby efficiently improving integration of the interconnection structure and device electromigration. Additionally, the nitrosilicide layer 142 also serves as a barrier layer that prevents the underlying conductive layer 126 from diffusing to the adjacent dielectric layer, thereby improving electromigration performance and overall device electrical performance.

In step 408, while maintaining the plasma process conditions used to form the nitrogen containing plasma, a second silicon based compound is flowed over the surface of the substrate to form an interface adhesion layer 144 on the substrate 100, as shown in FIG. 5D. The interface adhesion layer 144 may be deposited on the substrate 100 by flowing a second silicon based compound over the substrate 100 while maintaining plasma conditions such as RF power used for forming the nitrosilicide layer 142. In certain embodiments, the second silicon based compound is the same as the first silicon based compound. In certain embodiments, the interface adhesion layer 144 is a silicon nitride layer with a thickness between about 1 Å and about 100 Å, for example, between about 2 Å and about 50 Å, such as between about 3 Å and about 10 Å. In certain embodiments, where the interface adhesion layer 144 is silicon nitride, the silicon nitride layer has a low hydrogen content.

In step 410 a barrier dielectric layer 146 is deposited on the interface adhesion layer 144 formed on the substrate 100 as shown in FIG. 5E. In certain embodiments, the barrier dielectric layer 146 may comprise a silicon carbide material or other suitable dielectric material. After the interface adhesion layer 144 is formed, the barrier dielectric layer 146 may be subsequently deposited thereon. The formation of the metal nitrosilicide layer 142, the interface adhesion layer 144, and the barrier dielectric layer 146 may be performed in-situ. Processes for depositing the barrier dielectric layer 146 are described in U.S. Pat. No. 6,537,733, entitled METHOD OF DEPOSITING LOW DIELECTRIC CONSTANT SILICON CARBIDE LAYERS, U.S. Pat. No. 6,759,327, entitled DEPOSITING LOW K BARRIER FILMS (k<4) USING PRECURSORS WITH BULKY ORGANIC FUNCTIONAL GROUPS, and U.S. Pat. No. 6,890,850, entitled METHOD OF DEPOSITING LOWER K HARDMASK AND ETCH STOP FILMS, which are all incorporated herein by reference in their entireties to the extent not inconsistent with the claimed aspects and disclosure herein. In one embodiment, where the barrier dielectric layer 146 comprises silicon carbide, an organosilicon compound may be introduced into the processing chamber and a silicon carbide layer deposited on the interface adhesion layer 144. Dopants, such as nitrogen containing compounds, including ammonia, may be used to form nitrosilicides with the conductive material. Additionally, suitable silicon based compounds, may additionally perform as a reducing compound to remove any oxides formed on the conductive materials. Further, an inert plasma treatment may be performed on the substrate surface prior to introducing the silicon based compound. In certain embodiments an amorphous carbon layer such as BLACK DIAMOND® may be deposited on the dielectric barrier layer 146.

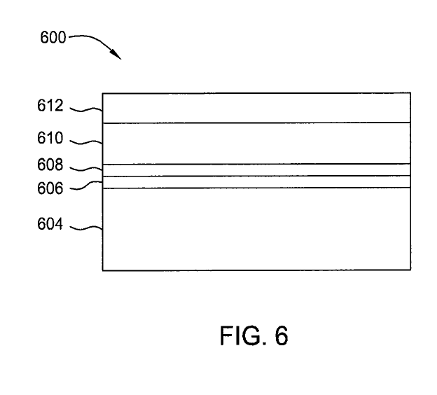

FIG. 6 is a cross-sectional view of a structure 600 including a transitional layer 606 and a thin interface adhesion layer 608 formed according to embodiments described herein. The structure 600 includes a transitional layer 606 and a thin interface adhesion layer 608 that is deposited on a substrate 604 with a dielectric barrier layer 610 deposited on the thin interface adhesion layer 608. The substrate 604 may comprise conductive, semiconductive, insulating layers, or combinations thereof. In certain embodiments, the substrate 604 comprises a conductive material selected from the group consisting of Sn, Ni, Cu, Au, Al, and combinations thereof. In certain embodiments, the substrate 604 comprises a combination of conductive, semiconductive, and insulating layers, for example, silicon with an optional silicon oxide layer deposited thereon and a conductive material such as copper deposited on the silicon oxide layer. The structure 600 also includes a dielectric barrier layer 610, such as silicon carbide, deposited on the thin interface adhesion layer 608. The transitional layer 606 may comprise a combination of the conductive material of substrate 604 and the material of the interface adhesion layer 608. For example, in embodiments wherein the conductive material comprises copper and the interface adhesion layer comprises SiN, the transitional layer comprises a nitrosilicide such as CuSiN. In certain embodiments, the thin interface adhesion layer 608 is deposited using RF back-to-back techniques according to embodiments described herein. In certain embodiments an amorphous carbon layer 612 such as BLACK DIAMOND® may be deposited on the dielectric barrier layer 610.

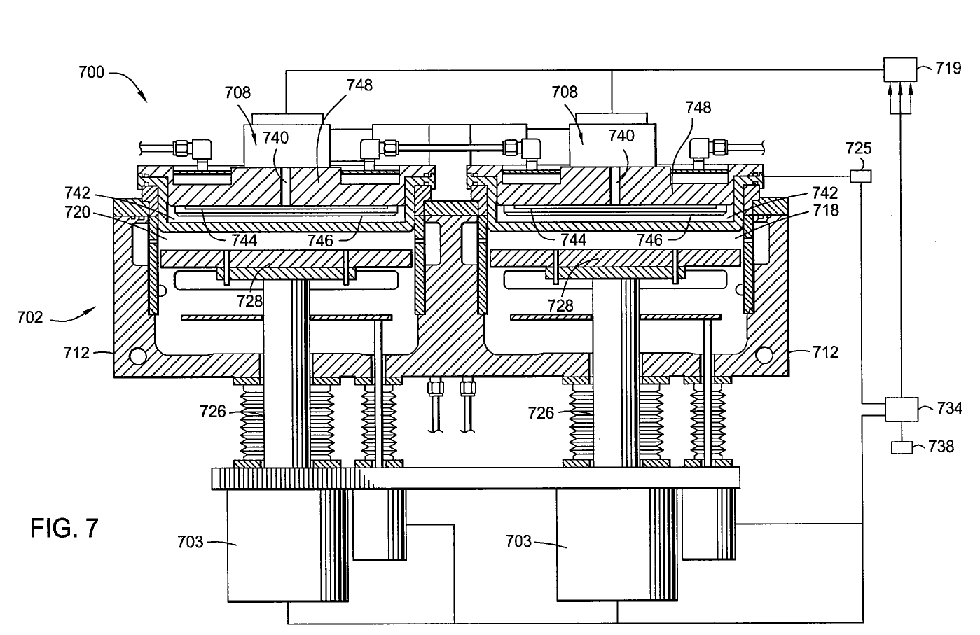

FIG. 7 is a cross sectional schematic diagram of a chemical vapor deposition chamber 700 that may be used for practicing embodiments of the invention. An example of such a chamber is a dual or twin chamber on a PRODUCER® system, available from Applied Materials, Inc. of Santa Clara, Calif. The twin chamber has two isolated processing regions (for processing two substrates, one substrate per processing region) such that the flow rates experienced in each region are approximately one half of the flow rates into the whole chamber. The flow rates described in the examples below and throughout the specification are the flow rates per 300 mm substrate. A chamber having two isolated processing regions is further described in U.S. Pat. No. 5,855,681, which is incorporated by reference herein. Another example of a chamber that may be used is a DxZ® chamber on a CENTURA® system, both of which are available from Applied Materials, Inc.

The CVD chamber 700 has a chamber body 702 that defines separate processing regions 718, 720. Each processing region 718, 720 has a pedestal 728 for supporting a substrate (not shown) within the CVD chamber 700. Each pedestal 728 typically includes a heating element (not shown). Preferably, each pedestal 728 is movably disposed in one of the processing regions 718, 720 by a stem 726 which extends through the bottom of the chamber body 702 where it is connected to a drive system 703.

Each of the processing regions 718, 720 also preferably includes a gas distribution assembly 708 disposed through a chamber lid to deliver gases into the processing regions 718, 720. The gas distribution assembly 708 of each processing region normally includes a gas inlet passage 740 which delivers gas from a gas flow controller 719 into a gas distribution manifold 742, which is also known as a showerhead assembly. Gas flow controller 719 is typically used to control and regulate the flow rates of different process gases into the chamber. Other flow control components may include a liquid flow injection valve and liquid flow controller (not shown) if liquid precursors are used. The gas distribution manifold 742 comprises an annular base plate 748, a face plate 746, and a blocker plate 744 between the base plate 748 and the face plate 746. The gas distribution manifold 742 includes a plurality of nozzles (not shown) through which gaseous mixtures are injected during processing. An RF (radio frequency) source 725 provides a bias potential to the gas distribution manifold 742 to facilitate generation of a plasma between the showerhead assembly 742 and the pedestal 728. During a plasma-enhanced chemical vapor deposition process, the pedestal 728 may serve as a cathode for generating the RF bias within the chamber body 702. The cathode is electrically coupled to an electrode power supply to generate a capacitive electric field in the deposition chamber 700. Typically an RF voltage is applied to the cathode while the chamber body 702 is electrically grounded. Power applied to the pedestal 728 creates a substrate bias in the form of a negative voltage on the upper surface of the substrate. This negative voltage is used to attract ions from the plasma formed in the chamber 700 to the upper surface of the substrate.

During processing, process gases are uniformly distributed radially across the substrate surface. The plasma is formed from one or more process gases or a gas mixture by applying RF energy from the RF power supply 725 to the gas distribution manifold 742, which acts as a powered electrode. Film deposition takes place when the substrate is exposed to the plasma and the reactive gases provided therein. The chamber walls 712 are typically grounded. The RF power supply 725 can supply either a single or mixed-frequency RF signal to the gas distribution manifold 742 to enhance the decomposition of any gases introduced into the processing regions 718, 720.

A system controller 734 controls the functions of various components such as the RF power supply 725, the drive system 703, the lift mechanism, the gas flow controller 719, and other associated chamber and/or processing functions. The system controller 734 executes system control software stored in a memory 738, which in the preferred embodiment is a hard disk drive, and can include analog and digital input/output boards, interface boards, and stepper motor controller boards. Optical and/or magnetic sensors are generally used to move and determine the position of movable mechanical assemblies.

The above CVD system description is mainly for illustrative purposes, and other plasma processing chambers may also be employed for practicing embodiments described herein.

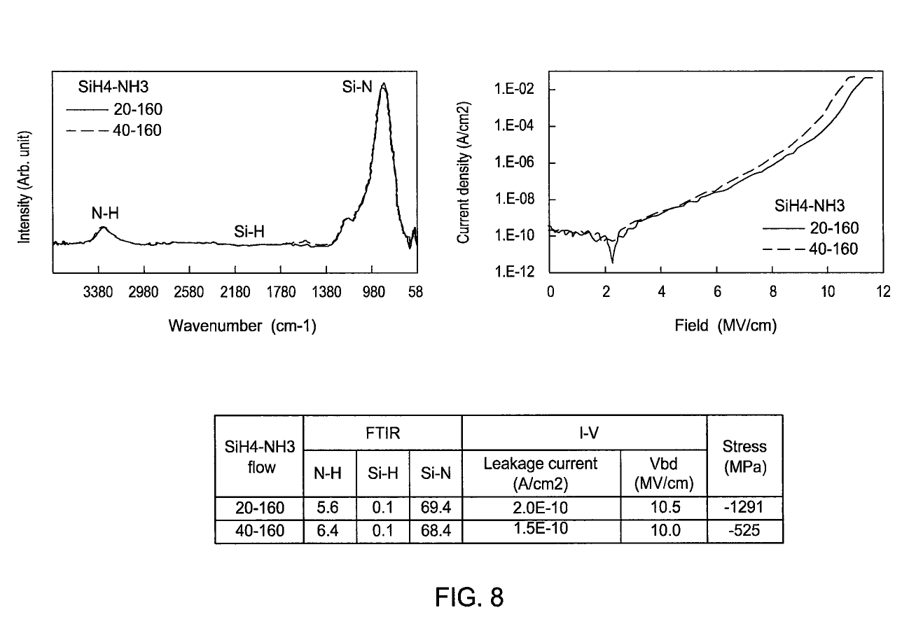

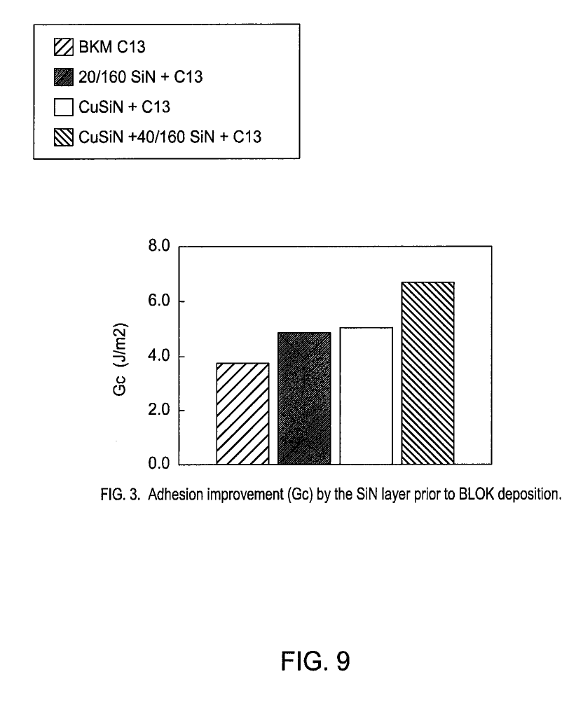

FIG. 8 is a graph demonstrating the FTIR spectra of candidate SiN films where low Si—H content is observed. Dielectric breakdown voltage is also measured at over 10 MV/cm which is much larger than that of bulk BLOK films.

FIG. 9 demonstrates interfacial adhesion energy improvement (Gc) by the SiN layer prior to silicon carbide deposition. The results of FIG. 9 were obtained by testing the structure 600 of FIG. 6. The results of FIG. 9 demonstrate that the adhesion of Cu is significantly enhanced by the addition of both CuSiN and SiN layers, respectively and in combination.

The following non-limiting examples are provided to further illustrate embodiments described herein. However, the examples are not intended to be all-inclusive and are not intended to limit the scope of the embodiments described herein.

### EXAMPLE

In the case of the combined CuSiN and SiN, a thin layer of CuSiN was formed by flowing trisilylamine over a Cu surface to form a silicide, followed by NH₃ plasma treatment of the silicide to form CuSiN and then SiN deposition. RF back-to-back was enabled (e.g. the RF power used for the NH₃ plasma treatment was maintained for the SiN deposition) and variations in process conditions were minimized to eliminate any abrupt interface between the two layers (CuSiN and SiN) and create a transition layer from CuSiN to SiN.

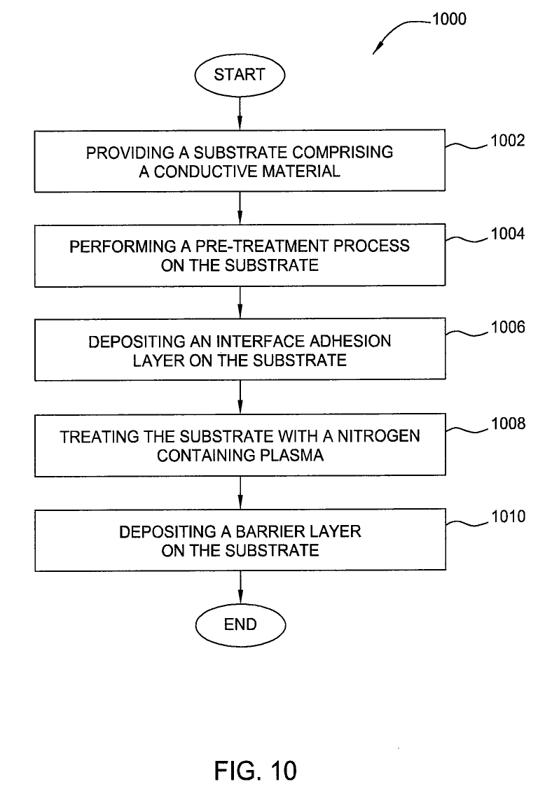

FIG. 10 is a process flow diagram illustrating another method 1000 according to one embodiment described herein for forming a thin interface adhesion layer on a substrate 100. The method 1000 starts at step 1002 by providing a substrate 100 comprising a conductive material 126 having an exposed surface 128 disposed on the substrate 100, as shown in FIG. 3A.

In step 1004, a pre-treatment process having nitrogen containing plasma is performed to treat the upper surface of the second dielectric layer 118 and the exposed surface 128 of the conductive material 126. The pre-treatment process may assist removing metal oxide, native oxide, particles, or contaminants from the substrate surface. In one embodiment, the gases utilized to treat the substrate 100 include N₂, N₂O, NH₃, NO₂, and the like. In a certain embodiment depicted herein, the nitrogen containing gas used to pre-treat the second dielectric layer 118 and the exposed surface 128 of the conductive material 126 is ammonia (NH₃) or nitrogen gas (N₂).

In one embodiment, the pre-treatment process is performed by generating a plasma in a gas mixture supplied to the processing chamber. The plasma may be generated by applying a power density ranging between about 0.03 W/cm² and about 3.2 W/cm², which is a RF power level of between about 10 W and about 1,000 W for a 300 mm substrate, for example, between about 100 W and about 400 W at a high frequency such as between 13 MHz and 14 MHz, for example, 13.56 MHz. The plasma may be generated by applying a power density ranging between about 0.01 W/cm² and about 1.4 W/cm², which is a RF power level of between about 10 W and about 1,000 W for a 300 mm substrate, for example, between about 100 W and about 400 W at a high frequency such as between 13 MHz and 14 MHz, for example, 13.56 MHz. Alternatively, the plasma may be generated by a dual-frequency RF power source as described herein. Alternatively, all plasma generation may be performed remotely, with the generated radicals introduced into the processing chamber for plasma treatment of a deposited material or deposition of a material layer.

In step 1006, an interface adhesion layer 130, as shown in FIG. 3B, is formed on the substrate 100. In certain embodiments, the interface adhesion layer 130 is a silicon nitride layer with a thickness between about 1 Å and about 100 Å, between about 2 Å and about 50 Å, for example, between about 3 Å and about 10 Å. In certain embodiments, where the interface adhesion layer 130 comprises silicon nitride, the silicon nitride layer has a low hydrogen content. In one embodiment, the silicon nitride layer comprises a silicon rich silicon nitride (SiₓN_{y}) layer.

The interface adhesion layer 130 may be formed by flowing a silicon based compound over the treated surface of the conductive material 126. The silicon based compound may comprise a carbon-free silicon compound including silane (SiH₄), disilane (Si₂H₆), trisilane (Si₃H₈), trisilylamine ((SiH₃)₃N or TSA), derivatives thereof, and combinations thereof. The silicon based compound may also comprise a carbon-containing silicon compound including organosilicon compounds described herein, for example, methylsilane (CH₃SiH₃), trimethylsilane (TMS), derivatives thereof, and combinations thereof.

In certain embodiments, wherein the thin interface adhesion layer 130 is a silicon nitride layer, the silicon nitride layer may be deposited by flowing the silicon based compound to a processing chamber at a flow rate between about 50 sccm and about 1000 sccm, for example, between about 250 sccm and about 500 sccm, providing a nitrogen-containing compound, such as the reducing compounds described herein, to a processing chamber at a flow rate between about 500 sccm and about 2,500 sccm, for example, between about 1,250 sccm and about 1,750 sccm optionally providing an inert gas, such as helium or nitrogen, to a processing chamber at a flow rate between about 100 sccm and about 20,000 sccm, for example, between about 15,000 sccm and about 19,000 sccm, maintaining a chamber pressure between about 1 Torr and about 12 Torr, for example, between about 2.5 Torr and about 9 Torr, maintaining a heater temperature between about 100° C. and about 500° C., for example, between about 250° C. and about 450° C., positioning a gas distributor, or “showerhead”, between about 200 mils and about 1000 mils, for example between 300 mils and 500 mils from the substrate surface and generating a plasma. In one embodiment, the plasma treatment may be performed between about 1 second and about 10 seconds, for example, between about 1 second and about 5 seconds.

The plasma may be generated by applying a power density ranging between about 0.03 W/cm² and about 3.2 W/cm², which is a RF power level of between about 10 W and about 1,000 W for a 200 mm substrate, for example, between about 20 W and about 400 W, for example, between about 30 W and about 200 W at a high frequency such as between 13 MHz and 14 MHz, for example, 13.56 MHz. The plasma may be generated by applying a power density ranging between about 0.01 W/cm² and about 1.4 W/cm², which is a RF power level of between about 10 W and about 1,000 W for a 300 mm substrate, for example, between about 100 W and about 400 W at a high frequency such as between 13 MHz and 14 MHz, for example, 13.56 MHz. Alternatively, the plasma may be generated by a dual-frequency RF power source as described herein. Alternatively, all plasma generation may be performed remotely, with the generated radicals introduced into the processing chamber for plasma treatment of a deposited material or deposition of a material layer.

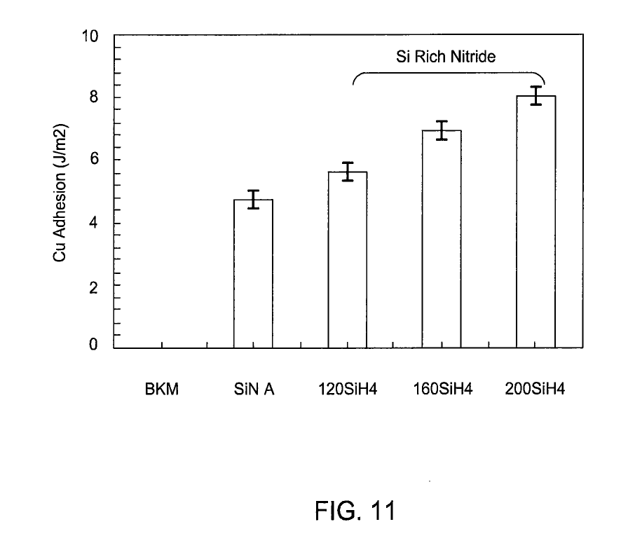

In one embodiment, the flow rates of the process gases are modified to increase the amount of silicon in the silicon nitride layer to produce a silicon rich silicon nitride layer. As shown in FIG. 11, an increase in the flow rate of silane gas yields a corresponding increase in adhesion to copper. For example, SiN A shows copper adhesion results of about 4.7 J/m² for a nitrogen rich silicon nitride. As the silane flow rates increase, the copper adhesion rates increase, for example, for 120 sccm of silane the copper adhesion is about 5.6 J/m² and for 160 sccm of silane the copper adhesion increase to about 6.8 J/m².

In step 1008, the interface adhesion layer 130 is treated with a nitrogen containing plasma to improve the dielectric properties of the interface adhesion layer 130. The nitrogen containing plasma is used to remove hydrogen from the as-deposited silicon rich interface adhesion layer and convert the composition of the interface adhesion layer 130 from silicon rich to nitrogen rich. Treatment of the interface adhesion layer 130 with a nitrogen plasma may also be used to tune the stress of the interface adhesion layer 130. For example, for embodiments where the interface adhesion layer 130 comprises silicon nitride, the as-deposited silicon nitride exhibits tensile stress. After nitridation of the as-deposited silicon nitride film, the treated silicon nitride film exhibits compressive stress. Thus treatment with the nitrogen containing plasma may be used to tune the stress of the interface adhesion layer 130.

The nitrogen source for the nitrogen containing plasma may be nitrogen (N₂), NH₃, N₂O, NO₂, or combinations thereof. The plasma may further comprise an inert gas, such as helium, argon, or combinations thereof. The pressure during the plasma exposure of the substrate may be between about 1 Torr and about 30 Torr, such as between about 1 Torr and about 10 Torr. Besides N₂, other nitrogen-containing gases may be used to form the nitrogen plasma, such as H₃N hydrazines (e.g., N₂H₄ or MeN₂H₃), amines (e.g., Me₃N, Me₂NH or MeNH₂), anilines (e.g., C₅H₅NH₂), and azides (e.g., MeN₃ or Me₃SiN₃). Other noble gases that may be used include helium, neon, and xenon. The nitridation process proceeds at a time period from about 10 seconds to about 360 seconds, for example, from about 0 seconds to about 60 seconds, for example, about 15 seconds.

The RF power selected to perform the nitridation treatment process may be controlled substantially similar to the RF power selected to perform the nitrogen plasma pre-treatment process of the substrate 100. In one embodiment, the plasma may be generated by applying a power density ranging between about 0.03 W/cm² and about 3.2 W/cm², which is a RF power level of between about 10 W and about 1,000 W for a 300 mm substrate, for example, between about 100 W and about 600, such as, between about 300 W and about 400 W at a high frequency such as between 13 MHz and 14 MHz, for example, 13.56 MHz. The plasma may be generated by applying a power density ranging between about 0.01 W/cm² and about 1.4 W/cm², which is a RF power level of between about 10 W and about 1,000 W for a 300 mm substrate, for example, between about 100 W and about 400 W at a high frequency such as between 13 MHz and 14 MHz, for example, 13.56 MHz. Alternatively, the plasma may be generated by a dual-frequency RF power source as described herein. Alternatively, all plasma generation may be performed remotely, with the generated radicals introduced into the processing chamber for plasma treatment of a deposited material or deposition of a material layer.

In one embodiment, the nitridation process is conducted with a RF power setting at about 300 watts to about 2,700 watts and a pressure at about 1 Torr to about 100 Torr. A nitrogen containing gas has a flow rate from about 0.1 slm to about 15 slm. In one embodiment, the nitrogen containing gas includes a gas mixture having a nitrogen and an ammonia gas is supplied into the processing chamber. The nitrogen gas is supplied to the chamber between about 0.5 slm and about 1.5 slm, for example, about 1 slm and the ammonia gas is supplied to the chamber between about 5 slm and about 15 slm, such as about 10 slm.

The individual and total gas flows of the processing gases may vary based upon a number of processing factors, such as the size of the processing chamber, the temperature of the processing chamber, and the size of the substrate being processed. The process chamber pressure may be maintained between about 1 Torr and about 10 Torr, for example, between about 2 Torr and about 5 Torr, such as about 3.7 Torr. The heater temperature may be maintained between about 100° C. and about 500° C., for example, between about 250° C. and about 450° C., such as less than 350° C.

In step 1010, a barrier dielectric layer 132 is deposited on the interface adhesion layer 130. In certain embodiments, the barrier dielectric layer 132 comprises a silicon carbide material. The subsequent barrier dielectric layer 132 may be deposited by, for example, by continuously introducing an organosilicon compound described herein or by adjusting the silicon carbide precursor gas flow rates and any dopants, carrier gases, or other compounds as described herein to deposit a silicon carbide layer having desired properties. The continuous flow of organosilicon precursor during or immediately following the reducing compound treatment process allows for the removal of oxides, the formation of a nitrated layer and deposition of the silicon carbide layer to be performed in-situ. Processes for depositing silicon carbide are described in U.S. Pat. No. 6,537,733, entitled METHOD OF DEPOSITING LOW DIELECTRIC CONSTANT SILICON CARBIDE LAYERS, U.S. Pat. No. 6,759,327, entitled DEPOSITING LOW K BARRIER FILMS (k<4) USING PRECURSORS WITH BULKY ORGANIC FUNCTIONAL GROUPS, and U.S. Pat. No. 6,890,850, entitled METHOD OF DEPOSITING LOWER K HARDMASK AND ETCH STOP FILMS, which are all incorporated herein by reference to the extent not inconsistent with the claimed aspects and disclosure herein.

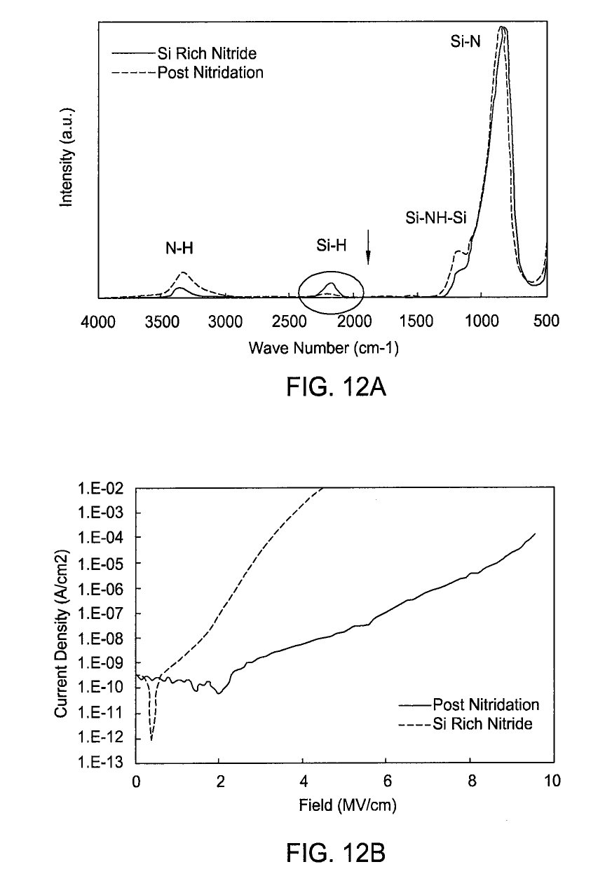

FIG. 12A is a graph demonstrating the FTIR spectra of candidate SiN films both pre-nitridation and post nitridation. The y-axis represents the intensity (a.u.) and the x-axis represents Wave Number (cm⁻¹).

FIG. 12B is a graph demonstrating the improvement in dielectric properties of a silicon nitride film after a post deposition nitridation treatment. The y-axis represents the current density (A/cm²) and the x-axis represents the Electric Filed (MV/cm). The results show that the silicon rich silicon nitride has poor leakage and a high Si—H content whereas after post nitridation treatment of the silicon rich silicon nitride layer, the Si—H content is reduced with a corresponding improvement in leakage results. The results show that silicon nitride dielectric properties may be dramatically improved with post deposition nitridation treatment over the dielectric properties of an untreated silicon rich silicon nitride.

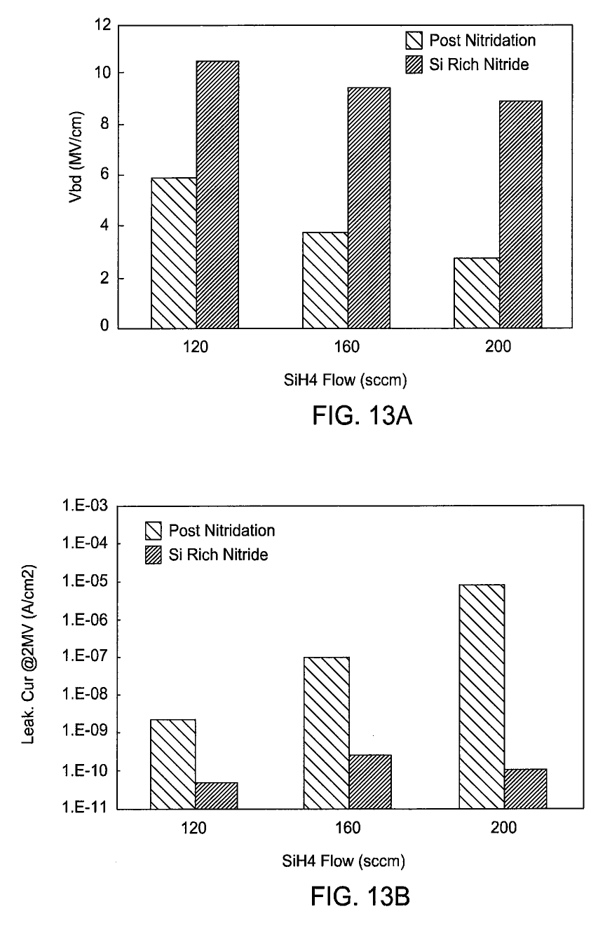

FIG. 13A is a graph demonstrating the improvement in breakdown voltage (Vbd) for a dielectric film after post deposition nitridation treatment. The y-axis of FIG. 12A represents breakdown voltage (Vbd) and the x-axis represents silane (SiH₄) flow rate (sccm). The graph demonstrates that post deposition nitridation treatment of silicon nitride demonstrates significant improvement in voltage breakdown (Vbd) over silicon rich silicon nitrides not receiving post-deposition nitridation treatment.

FIG. 13B is a graph demonstrating the improvement in leakage current at 2 MV (A/cm²) for a dielectric film after post deposition nitridation treatment. The y-axis represents leakage current at 2 MV (A/cm²) and the x-axis represents silane (SiH₄) flow rate (sccm). The graph demonstrates that post deposition nitridation treatment of silicon nitride demonstrates significant improvement in leakage current results over silicon rich silicon nitrides not receiving post-deposition nitridation treatment.

While the foregoing is directed to embodiments of the present invention, other and further embodiments of the invention may be devised without departing from the basic scope thereof, and the scope thereof is determined by the claims that follow.

1. A method for processing a substrate, comprising:
providing a substrate comprising a conductive material;
depositing an interface adhesion layer on the substrate;
exposing the interface adhesion layer to a nitrogen containing plasma; and
depositing a dielectric layer on the interface adhesion layer after exposing the interface adhesion layer to the nitrogen containing plasma.

2. The method of claim 1, wherein the interface adhesion layer comprises silicon nitride.

3. The method of claim 2, wherein the conductive material comprises copper.

4. The method of claim 3, wherein the dielectric layer comprises silicon carbide.

5. The method of claim 1, wherein the nitrogen containing plasma is generated by applying a power density ranging between about 0.03 W/cm² and about 3.2 W/cm²

6. The method of claim 1, wherein the interface adhesion layer is between about 1 Å and about 100 Å thick.

7. The method of claim 6, wherein the interface adhesion layer is between about 2 Å and about 50 Å thick.

8. A method for processing a substrate, comprising:
providing a substrate comprising a conductive material;
flowing a first silicon based compound over the surface of the conductive material to form a silicide layer;
treating the silicide layer with a nitrogen containing plasma to form a nitrosilicide layer;
depositing an interface adhesion layer on the substrate by flowing a second silicon based compound over the substrate while maintaining the nitrogen containing plasma; and
depositing a dielectric layer on the interface adhesion layer.

9. The method of claim 8, wherein the interface adhesion layer comprises silicon nitride.

10. The method of claim 9, wherein the conductive material comprises copper.

11. The method of claim 10, wherein the dielectric layer comprises silicon carbide.

12. The method of claim 8, wherein the first silicon based compound is selected from the group comprising silane (SiH₄), disilane (Si₂H₆), trisilane (Si₃H₈), trisilylamine ((SiH₃)₃N), derivatives thereof, and combinations thereof.

13. The method of claim 8, wherein the interface adhesion layer is between about 2 Å and about 50 Å thick.

14. The method of claim 13, wherein the interface adhesion layer is between about 3 Å and about 10 Å.

15. The method of claim 9, wherein the nitrosilicide is CuSiN.

16. The method of claim 8, wherein the nitrogen containing plasma is formed by applying RF power to a nitrogen containing gas.

17. The method of claim 16, wherein maintaining the plasma comprises maintaining the RF power used to form the nitrogen containing plasma.

18. The method of claim 8, wherein the treating the substrate with a nitrogen containing plasma to form a nitrosilicide and the depositing an interface adhesion layer on the substrate by flowing a second silicon based compound over the substrate while maintaining plasma conditions are performed using RF power back-to-back.

19. The method of claim 8, further comprising performing a pre-treatment process on the conductive material before flowing a first silicon based compound over the surface of the conductive material to form a silicide layer.

20. A method for processing a substrate, comprising:
providing a substrate comprising a conductive material;
flowing a first silicon based compound over the surface of the conductive material to form a silicide layer;
applying an RF power to form a nitrogen containing plasma;
treating the substrate with the nitrogen containing plasma to form a nitrosilicide;
depositing an interface adhesion layer on the substrate by flowing a second silicon based compound over the substrate while maintaining the RF power; and
depositing a dielectric layer on the substrate.
